(19) United States
(12) Patent Application Publication
(10) Pub. No.: US 2004/0267319 A1
(43) Pub. Date: Dec. 30, 2004

(54) Wrist teether for an infant

(76) Inventor: Kelly S. Stack, Concord, CA (US)

Correspondence Address: Darien K. Wallace, Suite 245, 6601 Koll Center Parkway, Pleasanton, CA, 94566, US

(21) Appl. No.: 10/602,446

(22) Filed: Jun. 24, 2003

(51) Int. Cl. A61J 17/00

(52) U.S. Cl. 606/235; 606/234

(57) ABSTRACT

A wrist teether relieves teething pain by cooling an infant's gums without causing either the infant or an adult the discomfort associated with handling a cold teether. The wrist teether is a doughnut-shaped bracelet containing cooled capsules, such as freezer cubes. The wrist teether attaches around the infant's wrist and permits the infant itself to apply the cooled capsules to its gums without grasping the teether. The wrist teether is elastic and constricts around the infant's wrist so that it does not fall off. A multi-layered wrist-facing side of the wrist teether insulates the infant's wrist from the cooled capsules.

### TECHNICAL FIELD

The present invention relates to infant care devices and more specifically to infant teethers.

### BACKGROUND

Teethers are devices that diminish the discomfort an infant experiences when the infant's teeth first protrude through the infant's gums. Teethers that are cooled can be more effective in relieving the pain associated with teething. Some teethers can be frozen, enabling the teether to cool and numb the infant's gums.

It is uncomfortable both for an infant and an adult to handle a conventional cooled teether. Most infants lack the manual dexterity and the attention to grasp an object for an extended period. Even where conventional teethers provide handles or rings, the infant tends to drop the teether. Moreover, the cooled teether will numb not only the infant's gums, but also the infant's hand, inducing the infant to drop the teether. An adult can use the handles or rings to insert the cooled teether into the infant's mouth. Adults often find holding teethers to be tedious. In addition, the adult's hand will become cold from the frozen teether.

FIG. 1 (prior art) shows a conventional cooled teether 10 that an adult 11 holds in an infant's mouth. Although the conventional cooled teether might pacify the infant, the cooled teether does not facilitate the adult's ability to perform other tasks while the infant is being pacified.

Thus, a teether is sought that relieves teething pain by cooling an infant's gums without causing either the infant or an adult the discomfort and tedium associated with holding a cold object.

### SUMMARY

A wrist teether relieves teething pain by cooling an infant's gums without causing either the infant or an adult the discomfort associated with handling a cold teether. In one embodiment, the wrist teether is a doughnut-shaped bracelet containing cooled capsules, such as freezer cubes that are filled with a liquid that can be frozen. The wrist teether attaches losely around the infant's wrist. The infant, therefore, need not grasp the wrist teether in order to apply the cooled capsules to its gums. The wrist teether is elastic and constricts around the infant's wrist so that it does not fall off. A multi-layered wrist-facing side of the wrist teether insulates the infant's wrist from the cooled capsules. Individual capsules bulge under a single layer of fabric on the outer side of the bracelet so that the infant can insert a portion of a cooled capsule into its mouth.

A method is disclosed for making a wrist teether from a rectangular piece of fabric.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (prior art) is a depiction of an adult holding a cooled teether in an infant's mouth.

FIG. 2 is a depiction of an infant applying the wrist teether of the present invention to the infant's mouth.

FIG. 3 is a top-down view of the wrist teether of FIG. 2.

FIG. 4 is a cross-sectional side view of the wrist teether of FIG. 2.

FIG. 5 is a cross-sectional top view of the wrist teether of FIG. 2.

FIGS. 6A-G show steps in a method of making the wrist teether of FIG. 2 from a piece of cloth.

FIG. 7 is a flowchart of a method of making the wrist teether of FIG. 2.

### DETAILED DESCRIPTION

Reference will now be made in detail to some embodiments of the invention, examples of which are illustrated in the accompanying drawings.

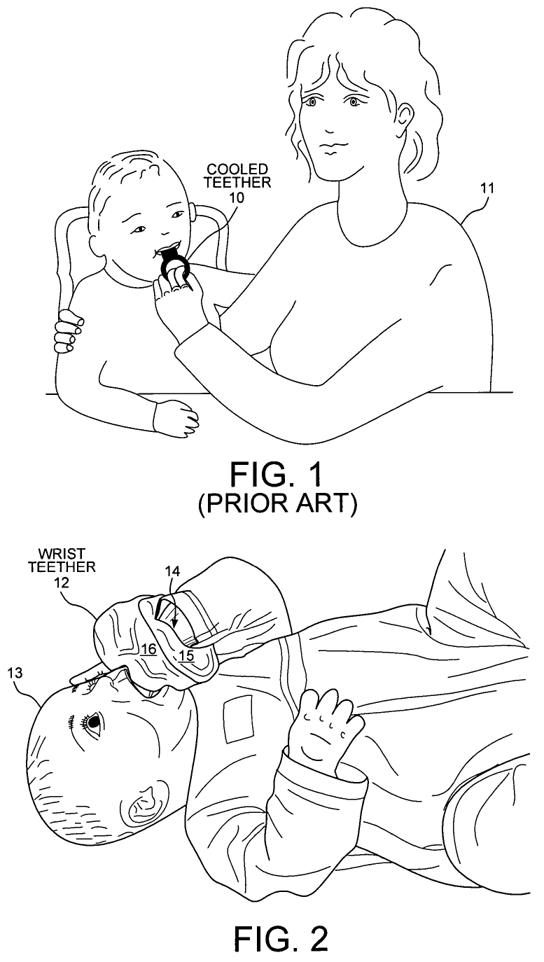

FIG. 2 shows a wrist teether 12 according to one specific embodiment of the present invention. An infant 13 is applying the wrist teether 12 to the infant's mouth by biting or gnawing or mouthing the cooled teether. The wrist teether 12 is toroidal and doughnut-shaped and resembles a bracelet. The wrist teether 12 passes around a wrist 14 of the infant 13. The wrist teether 12 is elastic and constricts in a very soft and loose manner around the wrist 14 of the infant 13. The wrist teether 12 is attached to the infant's wrist 14 without the infant 13 grasping the wrist teether 12.

The wrist teether 12 has a fabric shell and contains several capsules. The capsules contain a substance that can be frozen, for example, by placing the wrist teether 12 in a freezer. Alternatively, the substance in the capsules can be cooled in a refrigerator. The infant's wrist 14 is insulated from the cooled or frozen substance in the capsules by several layers of fabric on an inside, wrist-facing side 15 of the fabric shell. An outer side 16 of the fabric shell has only one layer of fabric, allowing the frozen capsules to come in close proximity with the gums of the infant 13. The fabric shell of the wrist teether 12 is flexible and pliant and stretches over the contours of the capsules. The fabric permits a large portion of an individual capsule to bulge under the fabric and to fit into the mouth of the infant 13, without the capsule becoming a choking hazard.

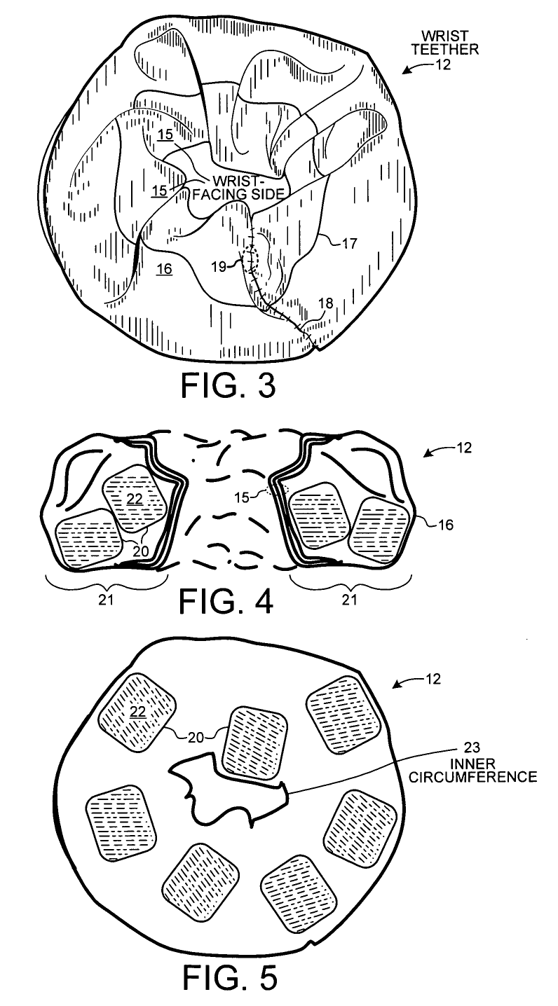

FIG. 3 is a top-down view of the wrist teether 12, showing a seam 17 that separates the wrist-facing side 15 of the fabric shell from the outer side 16. The stitching of the seam 17 is on the inside of the shell. An outside seam 18 connects two ends of a tube of fabric to form the doughnut-shaped bracelet that is the wrist teether 12. A few hand stitches 19 of the outside seam 18 are shown.

FIG. 4 is a cross-sectional side view of the wrist teether 12, showing capsules 20 within the shell of the wrist teether. The wrist-facing side 15 of the fabric shell has three layers of fabric, whereas the outer side 16 has only one layer. The wrist teether 12 has generally circular cross-sections 21 on either side of the center of its doughnut shape. The capsules 20 are filled with a substance 22 that can be cooled or frozen. For example, the capsules 20 can be plastic freezer cubes that are filled with a gel. Or the capsules 20 can be filled with water or a water solution. The capsules are smaller than the size of an infant's mouth in order to allow the infant 13 to suck on individual capsules through the fabric. The fabric should be non-absorbant so that it does not become wet with the infant's saliva or with condensation from the cold capsules 20. Wrist teether 12 is machine washable. Thus, the fabric can be a microfiber fabric that is machine washable, and the capsules 20 are made of a material that is not damaged by a washing machine.

FIG. 5 is a cross-sectional top view of wrist teether 12 showing how the capsules 20 are disbursed around the doughnut-shaped bracelet of wrist teether 12. When wrist-teether 12 is not over the infant's wrist 14, the doughnut-shape of wrist-teether 12 has an uneven inner circumference 23.

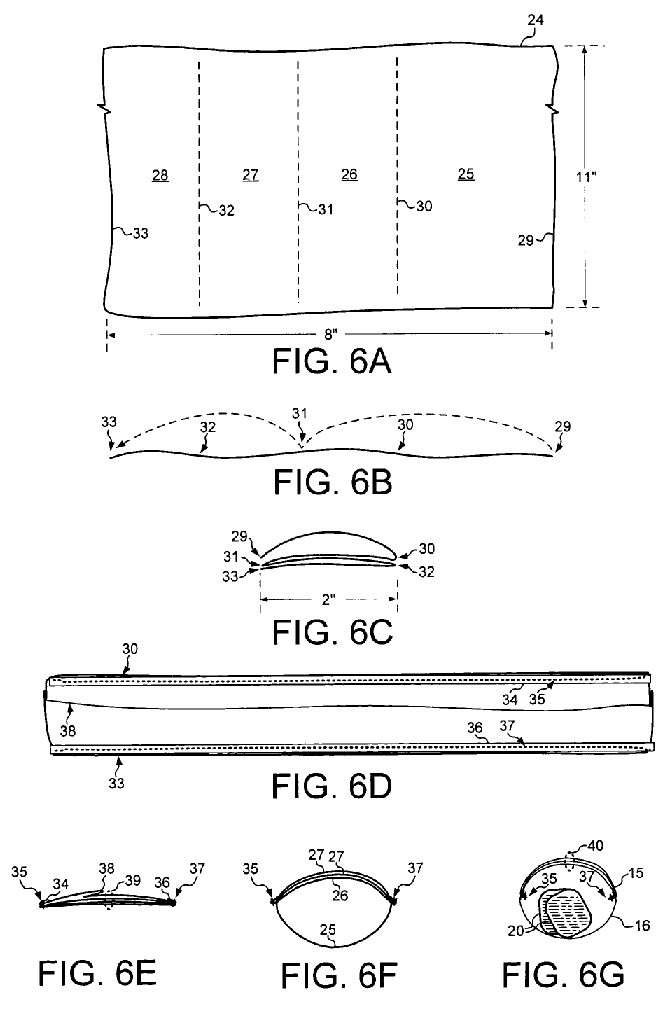

FIG. 6A is a top view of a rectangular piece of fabric 24 that is used to make wrist teether 12. FIGS. 6A through 6G illustrate steps in a method of making wrist teether 12. Fabric 24 has a length of about eleven inches and a width of about 8 inches. Fabric 24 is sectioned into four lengthwise strips, with a strip 25 on one side of fabric 24 being wider than the other three strips 26-28. An edge 29 of fabric 24 forms one of the longer sides of wider strip 25. The other longer side of wider strip 25 is a crease 30. Two other creases 31 and 32 separate the three narrow strips 26-28. Opposite crease 32 of narrow strip 28 is an edge 33 of fabric 24. The wider strip 25 becomes the outer side 16 of the fabric shell. The three narrow strips 26-28 become the wrist-facing side 15.

FIG. 6B shows a side view of the piece of fabric 24 and illustrates how the fabric 24 is folded before two seams are sewn. Edge 29 is brought into contact with crease 31, and crease 31 is folded over onto edge 33.

FIG. 6C shows the piece of fabric 24 after it has been folded at creases 30-32. As wider strip 25 has more fabric 24 than the other three strips 26-28, there is more fabric 24 between crease 30 and edge 33 than between crease 32 and edge 33.

FIG. 6D shows a top view of the folded fabric 24 of FIG. 6C, on which two seams have been sewn. A first elastic band 34 is stretched and laid along crease 30. Then a first seam 35 is sewn near and parallel to crease 30, attaching crease 30 to crease 32, as well as attaching first elastic band 34 to fabric 24. A second elastic band 36 is stretched and laid along edge 29, which lies above crease 31 and edge 33. Then a second seam 37 is sewn near and parallel to edge 29, attaching edge 29 to crease 31 and to edge 33, as well as attaching second elastic band 34 to fabric 24. A sewing machine can be used to sew seams 35 and 37. The excess fabric 24 between crease 30 and edge 33 forms a fold 38.

FIG. 6E shows a side view of the folded fabric 24 of FIG. 6D, into which first seam 35 and second seam 37 have been sewn. The excess fabric 24 of wider strip 25 forms fold 38. Folded fabric 24 now has four layers 39.

FIG. 6F shows how wider strip 25 is pulled to one side, while the other three strips 26-28 are pulled to the other side. A tube of fabric 24 is formed, with seams 35 and 37 on the outside of the tube.

In FIG. 6G, the tube of fabric 24 of FIG. 6F has been turned inside out. Seams 35 and 37, as well as elastic bands 34 and 36, are now on the inside of the tube of fabric 24. Several capsules 20 filled with freezable liquid are inserted into the tube of fabric 24. Three layers 40 of fabric 24 form wrist-facing side 15 of the fabric shell of wrist teether 12 and insulate the infant's wrist 14 from the cold capsules 20. Outer side 16 of the fabric shell has only one layer of fabric 24, which is more pliant than the three layers 40. Thus, infant 13 can more easily use its lips to move a capsule 20 that is on the other side of a single layer of fabric 24.

In a final step, the two ends of the tube of fabric 24 are sewn together in such a way that the three-layered wrist-facing side 15 is on the inside of the resulting doughnut-shaped bracelet. The two ends of the tube can be connected by sewing a connecting seam through all the layers with a sewing machine. This creates an area near the connecting seam that cannot be occupied by larger-sized capsules. Alternatively, the two ends of the tube can be hand sewn together, maintaining a toroid shape of wrist teether 12. Elastic bands 34 and 36 are stretched as they are sewn into seams 35 and 37. In their contracted state, elastic bands 34 and 36 reduce inner circumference 23 (shown in FIG. 5) and impart a doughnut shape to wrist teether 12.

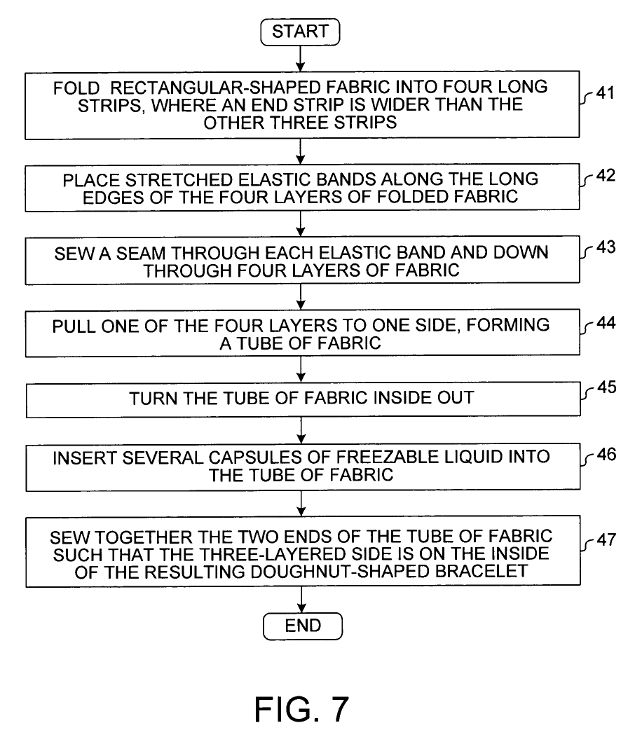

FIG. 7 is a flowchart showing seven steps 41-47 in a method of making wrist teether 12.

In accordance with another embodiment of the invention, a tag or label is added to the outer side 16 of the wrist teether 12 explaining how to use the bracelet. The label explains that wrist teether 12 is placed in a freezer for at least a few hours before the teether is placed on wrist 14 of teething infant 13.

Although the present invention has been described in connection with certain specific embodiments for instructional purposes, the present invention is not limited thereto. In the embodiments described above, the wrist teether has two elastic bands. In another embodiment, however, the shell of the wrist teether is made of elastic material. The purpose of the elastic bands is obviated where the material itself is elastic. In yet another embodiment, a separate elastic band within the volume of the doughnut-shaped wrist teether is used instead of sewing two elastic bands into the seams of the wrist teether.

Although the wrist teether in the embodiments described above are made of fabric, the shells of other embodiments of the wrist teether are made of plastic polymers or even of leather. Plastic shells of wrist teethers can be made without stitching by glueing or melting the seams. Two thicknesses of plastic can be used instead of various numbers of layers of fabric. In other embodiments, the number of layers on the wrist-facing side of the wrist teether is other than three. In yet other embodiments, the capsules are not individual cubes, but rather are a single structure with several compartments. A wrist teether need not include a doughnut-shaped container of fabric that encloses cooled capsules, but rather may include a single ring structure of compartments where the wrist-facing side of the ring is covered with an insulating layer.

Although the wrist teether is used primarily to relieve teething pain by cooling an infant's gums, the wrist teether can also be used to relieve pain by cooling scrapes and bumps on children. Accordingly, various modifications, adaptations, and combinations of various features of the described embodiments can be practiced without departing from the scope of the invention as set forth in the claims.

What is claimed is:

1. An apparatus, comprising:
a bracelet, the bracelet enclosing a volume and attached around an infant's wrist; and
a plurality of capsules within the volume, each of the plurality of capsules containing a substance that is liquid at room temperature.

2. The apparatus of claim 1, wherein the bracelet is elastic and has an inner circumference, and wherein the inner circumference increases when the bracelet is stretched.

3. The apparatus of claim 1, wherein each of the plurality of capsules has a rigid covering.

4. The apparatus of claim 1, wherein the substance is comprised of a water solution.

5. The apparatus of claim 1, wherein the substance is frozen.

6. The apparatus of claim 1, wherein the bracelet is made of a pliant material, is doughnut-shaped and has a wrist-facing side and an outer side opposite the wrist-facing side.

7. The apparatus of claim 6, wherein the pliant material is taken from the group consisting of: a woven fabric, a plastic polymer, and leather.

8. The apparatus of claim 6, wherein the pliant material is elastic.

9. The apparatus of claim 6, wherein the pliant material is less thermally conductive on the wrist-facing side of the bracelet than on the outer side.

10. The apparatus of claim 6, wherein the pliant material has plural layers on the wrist-facing side of the bracelet and a single layer elsewhere on the bracelet.

11. A method, comprising:
(a) enclosing a substance in a bracelet;
(b) attaching the bracelet to a wrist of an infant; and
(c) insulating the wrist of the infant from a temperature of the substance.

12. The method of claim 11, further comprising, after step (a) and before step (b):
(d) cooling the substance.

13. The method of claim 11, wherein the bracelet encloses a volume, and wherein the attaching the bracelet in step (b) involves inserting the infant's wrist into the bracelet.

14. The method of claim 13, wherein the bracelet is elastic and has an inner circumference, and wherein the attaching the bracelet in step (b) further involves stretching the bracelet such that the inner circumference of the bracelet is increased.

15. The method of claim 11, wherein the substance is enclosed within a plurality of capsules, each of the plurality of capsules having a rigid covering.

16. The method of claim 11, wherein the bracelet is made of a pliant material, is doughnut-shaped and has an inside, wrist-facing side.

17. The method of claim 16, wherein the insulating the wrist of the infant in step (c) involves making the pliant material thicker on the wrist-facing side of the bracelet than on an outer side of the bracelet.

18. The method of claim 11, wherein the insulating the wrist of the infant in step (c) involves providing the bracelet with plural layers of a pliant material at a location where the bracelet contacts the wrist of the infant.

19. A teether, comprising:
a cooled substance; and
means for attaching the cooled substance to a wrist of an infant, for applying the cooled substance to gums of the infant, and for insulating the wrist of the infant from the cooled substance.

20. The apparatus of claim 19, wherein the means constricts around the wrist of the infant.
